(19) United States
(12) Patent Application Publication
(10) Pub. No.: US 2025/0023251 A1
(43) Pub. Date: Jan. 16, 2025

(54) Antenna, Radar, and Terminal

(71) Applicant: Huawei Technologies Co., Ltd., Shenzhen (CN)

(72) Inventor: Daqing Liu, Shenzhen (CN)

(21) Appl. No.: 18/902,093

(22) Filed: Sep. 30, 2024

Related U.S. Application Data
(63) Continuation of application No. PCT/CN2023/079128, filed on Mar. 1, 2023.

(30) Foreign Application Priority Data
Mar. 31, 2022 (CN) 202210344863.5

(51) Int. Cl. H01Q 13/20; G01S 7/03

(52) U.S. Cl. CPC H01Q 13/206; G01S 7/03

(57) ABSTRACT

An antenna includes a waveguide structure, a radiating element, and a microstrip structure. The waveguide structure has a first slot and a second slot, and a length direction of the first slot is parallel to a length direction of the second slot. The microstrip structure may include a first microstrip and a second microstrip. A first feeding part of the first microstrip is arranged orthogonally to a second feeding part of the second microstrip. The first microstrip is coupled to the first slot, the first feeding part is connected to the radiating element for feeding, the second microstrip is coupled to the second slot, and the second feeding part is connected to the radiating element for feeding.

### CROSS-REFERENCE TO RELATED APPLICATIONS

This is a continuation of International Patent Application No. PCT/CN2023/079128 filed on Mar. 1, 2023, which claims priority to Chinese Patent Application No. 202210344863.5 filed on Mar. 31, 2022. The disclosures of the aforementioned applications are hereby incorporated by reference in their entireties.

### TECHNICAL FIELD

This disclosure relates to the field of communication technologies, and in particular, to an antenna, a radar, and a terminal.

### BACKGROUND

A circularly polarized wave can be received by various linearly polarized antennas, and is widely applicable. The circularly polarized wave can suppress rain and fog interference and resist multipath reflection in mobile communication. Therefore, the circularly polarized wave is widely used in fields such as satellite communication and navigation. The circularly polarized wave is a constant amplitude rotating field that can be decomposed into two orthogonal linearly polarized waves with a constant amplitude and a phase difference of 90°.

During actual application, various types of antennas can generate the circularly polarized wave. For example, in a slotted waveguide antenna, two slots perpendicular to each other are usually provided on a waveguide, and electromagnetic waves in the waveguide can leak signals through the slots, to be propagated outwards. A distance between the two slots is adjusted, so that the leaked signals have a constant amplitude and a phase difference of 90°, thereby generating the circularly polarized wave. However, arrangement of this structure is unconducive to controlling phases and amplitudes of the signals leaked from the slots, and cannot ensure circular polarization performance. In addition, the two slots need to be perpendicular to each other. This causes large disturbance to the electromagnetic waves propagated in the waveguide, causes leakage of a large amount of energy, accelerates attenuation of the electromagnetic waves in the waveguide, and is unconducive to ensuring a gain of the antenna.

### SUMMARY

This disclosure provides an antenna, a radar, and a terminal that can effectively ensure circular polarization performance and help improve a gain.

According to one aspect, this disclosure provides an antenna, including a waveguide structure, a radiating element, and a microstrip structure. The waveguide structure has a slot pair for leaking an electromagnetic wave, the slot pair includes a first slot and a second slot, and a length direction of the first slot is parallel to a length direction of the second slot. The radiating element is configured to transmit or receive the electromagnetic wave. The microstrip structure may include a first microstrip and a second microstrip. The first microstrip has a first feeding part, the second microstrip has a second feeding part, the first feeding part is arranged orthogonally to the second feeding part, and a phase difference between an electromagnetic wave of the first feeding part and an electromagnetic wave of the second feeding part is an odd multiple of 90°. The first microstrip is coupled to the first slot, the first feeding part is connected to the radiating element for feeding, the second microstrip is coupled to the second slot, and the second feeding part is connected to the radiating element for feeding.

In summary, amplitudes and polarization directions of signals leaked from the first slot and the second slot are the same. When the signals are propagated in the first microstrip and the second microstrip, because the first feeding part is arranged orthogonally to the second feeding part, the polarization directions of the two signals change from an identical state to an orthogonal state. In addition, when the two signals are fed into the radiating element, a phase difference is 90°, so that the radiating element can be excited to generate a circularly polarized wave.

In the antenna provided in this embodiment of this disclosure, the first slot and the second slot have a same length direction, that is, the first slot is parallel to the second slot. This can reduce design difficulty, and can effectively reduce disturbance of the first slot and the second slot to signals propagated in the waveguide structure, and help ensure signal transmission quality. In addition, the amplitudes of the signals leaked from the first slot and the second slot can be reduced, thereby helping improve a gain of the antenna. In addition, the first feeding part is arranged orthogonally to the second feeding part, and a polarization direction of an electromagnetic wave may be adjusted through the microstrip structure, so that directions of the two signals fed into the radiating element can be perpendicular to each other, thereby enabling the radiating element to generate a circularly polarized wave.

In an example, the waveguide structure may include a sub-waveguide, and the first slot and the second slot in the slot pair may both be located in the sub-waveguide. Alternatively, it may be understood that the first slot and the second slot may be located in a same sub-waveguide.

In addition, in a specific configuration, the waveguide structure may include a plurality of sub-waveguides, and the plurality of sub-waveguides may be arranged in parallel.

In addition, in a specific configuration, the waveguide structure may further include a main waveguide, the main waveguide has a plurality of output ends, and input ends of the plurality of sub-waveguides are coupled to the plurality of output ends in one-to-one correspondence. A signal (or an electromagnetic wave) may be input into the main waveguide through one end of the main waveguide, and propagated in the main waveguide. During the propagation, the signal may be propagated to the sub-waveguide through an output end.

During actual application, a phase of the signal propagated to the sub-waveguide may be adjusted by adjusting a position of the output end.

In addition, when there are the plurality of sub-waveguides, the first slot and the second slot in the slot pair may be respectively located in different sub-waveguides.

For example, two sub-waveguides in the plurality of sub-waveguides may form a sub-waveguide pair. One sub-waveguide in the sub-waveguide pair may be referred to as a first sub-waveguide, and the other sub-waveguide may be referred to as a second sub-waveguide. The first slot is located in the first sub-waveguide, and the second slot is located in the second sub-waveguide.

Certainly, the waveguide structure includes a plurality of sub-waveguide pairs, and the plurality of sub-waveguide pairs are arranged in parallel.

In addition, the waveguide structure may further include a main waveguide, and the main waveguide includes a plurality of first output ends and second output ends that are arranged in pairs. Input ends of a plurality of first sub-waveguides are coupled to the plurality of first output ends in one-to-one correspondence, and input ends of a plurality of second sub-waveguides are coupled to the plurality of second output ends in one-to-one correspondence.

When the first output end and the second output end are disposed, the plurality of first output ends and second output ends that are arranged in pairs are distributed on two sides of the main waveguide that face away from each other. In this way, a length of the main waveguide is shortened, and a propagation path between an input end of the main waveguide and an input end of the sub-waveguide is reduced.

In addition, in a specific configuration, the first slot or the second slot may be shared in two adjacent slot pairs. A quantity of provided slots can be effectively reduced by providing a shared slot. In addition, this helps increase layout density of the antenna.

When a structure of the antenna is further configured, the waveguide structure, the radiating element, and the microstrip structure in the antenna may be stacked. Certainly, during specific implementation, relative positions of the waveguide structure, the radiating element, and the microstrip structure may be flexibly configured based on an actual situation. This is not limited in this disclosure.

In addition, in an example, the antenna may further include a phase shifter. The phase shifter is connected to the first microstrip or the second microstrip, and is configured to adjust a phase of an electromagnetic wave fed into the radiating element.

In summary, during actual application, a phase difference of electromagnetic waves fed into a corresponding radiating element may be an odd multiple of 90° by adjusting positions of the first slot and the second slot in the slot pair, lengths of the first microstrip and the second microstrip, and relative positions of the output ends of the main waveguide, to enable the radiating element to generate circularly polarized radiation.

According to another aspect, this disclosure further provides a radar. The radar may include a housing and any one of the foregoing antennas. The antenna may be disposed in the housing.

In terms of electrical performance, the housing has good electromagnetic wave penetrability, so that normal receiving and sending of an electromagnetic wave between the antenna and the outside are not affected. In terms of mechanical performance, the housing has good force-bearing performance, antioxidation performance, and the like, so that the housing can withstand corrosion of an external harsh environment, and can protect the antenna well. It may be understood that, during specific application, a specific shape and material of the housing may be properly configured based on an actual situation. This is not limited in this disclosure.

According to another aspect, this disclosure further provides a terminal. The terminal may include a controller and the foregoing radar. The controller may be connected to an antenna. Further, the controller may be connected to a waveguide structure in the antenna, to control a working status of the antenna to perform effective control. The terminal may be a vehicle, a ship, a satellite, a flight, an uncrewed aerial vehicle, or the like. A specific application scenario of the radar (or the antenna) is not limited in this disclosure.

### BRIEF DESCRIPTION OF DRAWINGS

FIG. 1 is a diagram of an application scenario of an antenna according to an embodiment of this disclosure;

FIG. 2 is a diagram of another application scenario of an antenna according to an embodiment of this disclosure;

FIG. 3 is a diagram of a planar structure of an antenna according to an embodiment of this disclosure;

FIG. 4 is a diagram of a three-dimensional structure of a slot antenna with a rectangular waveguide according to an embodiment of this disclosure;

FIG. 5 is another diagram of a planar structure of a slot antenna with a rectangular waveguide according to an embodiment of this disclosure;

FIG. 6 is a diagram of electric field distribution when a signal is propagated in the slot antenna with a rectangular waveguide shown in FIG. 5;

FIG. 7 is a diagram of a three-dimensional structure of an antenna according to an embodiment of this disclosure;

FIG. 8 is a diagram of a cross-sectional structure of an antenna according to an embodiment of this disclosure;

FIG. 9 is a diagram of a partial planar structure of an antenna according to an embodiment of this disclosure;

FIG. 10 is a diagram of a partial planar structure of another antenna according to an embodiment of this disclosure;

FIG. 11 is a diagram of a planar structure of another antenna according to an embodiment of this disclosure;

FIG. 12 is a diagram of a planar structure of another antenna according to an embodiment of this disclosure;

FIG. 13 is a diagram of a partial three-dimensional structure of another antenna according to an embodiment of this disclosure;

FIG. 14 is a diagram of electric field distribution when a signal is propagated in a waveguide structure shown in FIG. 13;

FIG. 15 is a diagram of another electric field distribution when a signal is propagated in a waveguide structure shown in FIG. 13;

FIG. 16 is a diagram of a planar structure of another antenna according to an embodiment of this disclosure;

FIG. 17 is a diagram of electric field distribution when a signal is propagated in a waveguide structure shown in FIG. 16;

FIG. 18 is a diagram of a planar structure of another antenna according to an embodiment of this disclosure;

FIG. 19 is a diagram of a planar structure of another antenna according to an embodiment of this disclosure;

FIG. 20 is a diagram of electric field distribution when a signal is propagated in a waveguide structure shown in FIG. 19;

FIG. 21 is a diagram of a planar structure of another antenna according to an embodiment of this disclosure;

FIG. 22 is a diagram of simulated data of an antenna according to an embodiment of this disclosure;

FIG. 23 is a diagram of a pattern of an antenna according to an embodiment of this disclosure; and

FIG. 24 is a diagram of simulation data of another antenna according to an embodiment of this disclosure.

### DESCRIPTION OF EMBODIMENTS

To make the objectives, technical solutions, and advantages of this disclosure clearer, the following further describes this disclosure in detail with reference to the accompanying drawings.

To facilitate understanding of an antenna provided in embodiments of this disclosure, the following first describes application scenarios of the antenna.

The antenna provided in embodiments of this disclosure is used in scenarios such as a satellite communication system and a ground communication system. Further, the antenna is used in a Long-Term Evolution (LTE) system, a 5th generation (5G) New Radio (NR) communication system, and a future communication system satellite-to-ground integrated communication system.

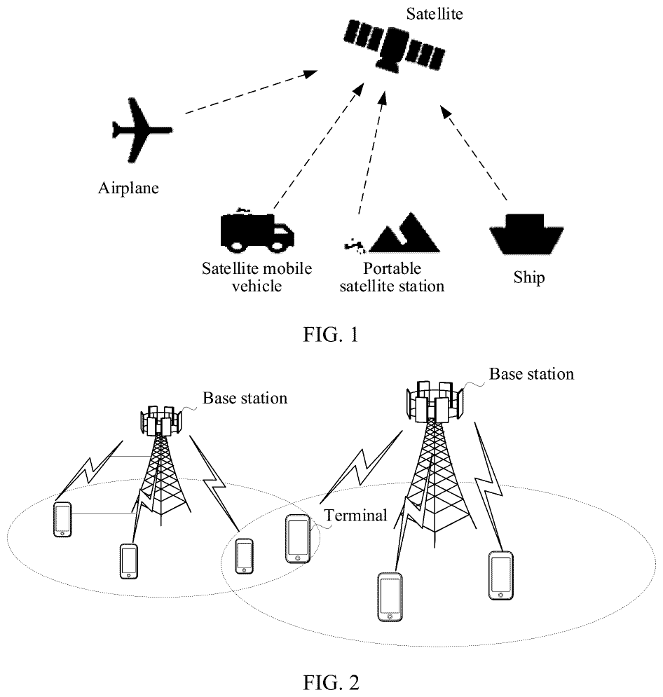

For example, as shown in FIG. 1, an application scenario provided in an embodiment of this disclosure may include a satellite, an airplane, a satellite mobile vehicle, a portable satellite station, a ship, or the like. An antenna may be configured in the foregoing satellite, airplane, satellite mobile vehicle, portable satellite station, and ship, to implement wireless communication between each device and a satellite.

Alternatively, as shown in FIG. 2, another application scenario provided in an embodiment of this disclosure may include a base station and a terminal. Wireless communication may be implemented between the base station and the terminal. The base station may be located in a base station subsystem (BSS), a terrestrial radio access network (e.g., Universal Mobile Telecommunications System (UMTS) terrestrial radio access network (UTRAN)), or an evolved UTRAN (E-UTRAN), and is configured to perform cell coverage of a radio signal, to implement communication between a terminal device and a wireless network. Further, the base station may be a base transceiver station (BTS) in a Global System for Mobile Communications (GSM) or a code-division multiple access (CDMA) system, may be a NodeB (NB) in a wideband CDMA (WCDMA) system, may be an evolved NodeB (eNB, or eNodeB) in an LTE system, or may be a radio controller in a cloud radio access network (CRAN) scenario. Alternatively, the base station may be a relay station, an access point, a vehicle-mounted device, a wearable device, a g node (gNodeB or gNB) in an NR system, a base station in a future evolved network, or the like. This is not limited in embodiments of this disclosure.

During actual application, the antenna can generate a circularly polarized wave. The circularly polarized wave can be received by various linearly polarized antennas, and is widely applicable. The circularly polarized wave can suppress rain and fog interference and resist multipath reflection in mobile communication. Therefore, the circularly polarized wave is widely used in fields such as satellite communication and navigation. The circularly polarized wave is a constant amplitude rotating field that can be decomposed into two orthogonal linearly polarized waves with a constant amplitude and a phase difference of an odd multiple of 90°.

During actual application, various types of antennas can generate the circularly polarized wave.

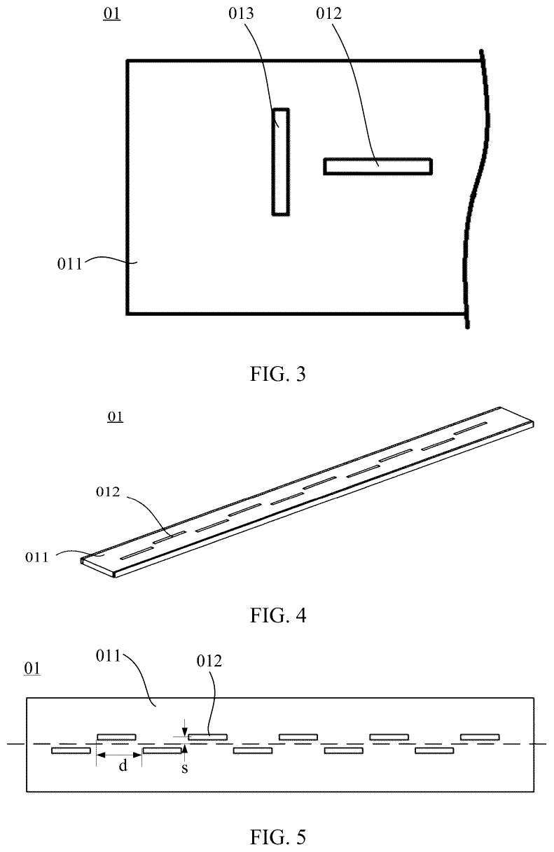

For example, as shown in FIG. 3, in a slotted waveguide antenna 01, two slots, namely, a slot 012 and a slot 013, perpendicular to each other are usually provided on a surface of a waveguide 011, and signals (or electromagnetic waves) in the waveguide 011 can be leaked from the slot 012 and the slot 013, to generate linearly polarized waves to be propagated outwards. Positions of the slot 012 and the slot 013 are adjusted, so that the leaked signals can have polarization directions perpendicular to each other, a constant amplitude, and a phase difference of 90°, thereby generating the circularly polarized wave. However, during actual application, arrangement of this structure is unconducive to controlling phases and amplitudes of the electromagnetic waves leaked from the slot 012 and the slot 013, and cannot ensure circular polarization performance. Further, the slot 012 and the slot 013 need to be perpendicular to each other to generate linearly polarized waves whose polarization directions are perpendicular to each other. Therefore, a requirement on machining precision is high. In addition, the slot 012 and the slot 013 perpendicular to each other cause large disturbance to the electromagnetic waves propagated in the waveguide 011, cause leakage of a large amount of energy, accelerate attenuation of the electromagnetic waves in the waveguide 011, and are unconducive to ensuring a gain of the antenna 01.

Therefore, an embodiment of this disclosure provides an antenna that can effectively ensure circular polarization performance and help improve a gain.

To make the objectives, technical solutions, and advantages of this disclosure clearer, the following further describes this disclosure in detail with reference to the accompanying drawings and specific embodiments.

Terms used in the following embodiments are merely intended to describe particular embodiments, but are not intended to limit this disclosure. Terms “one”, “a”, and “this” of singular forms used in this specification and the appended claims of this disclosure are also intended to include a form like “one or more”, unless otherwise specified in the context clearly. It should be further understood that, in the following embodiments of this disclosure, “at least one” means one, two, or more.

Reference to “an embodiment” or the like described in this specification means that one or more embodiments of this disclosure include a particular feature, structure, or characteristic described with reference to the embodiment. Therefore, in this specification, statements, such as “in an embodiment”, “in some implementations”, and “in other implementations”, that appear at different places do not necessarily mean referring to a same embodiment, instead, the statements mean referring to “one or more but not all of embodiments”, unless otherwise emphasized in other ways. Terms “include”, “have”, and variants of the terms all mean “including but not limited to”, unless otherwise emphasized in other ways.

For ease of understanding the technical solutions of this disclosure, the following first describes a radiation characteristic of a slotted waveguide antenna.

A working principle of the slotted waveguide antenna is to change current distribution on a surface of a waveguide by providing a slot on the surface of the waveguide, so that a signal (or an electromagnetic wave) propagated in the waveguide is leaked from the slot to generate antenna radiation.

FIG. 4 is a diagram of a three-dimensional structure of a slot antenna with a rectangular waveguide 01. A signal (or an electromagnetic wave) may be fed into a waveguide 011 from one end of the waveguide 011, so that the signal can be propagated to the other end along a length direction of the waveguide 011. In addition, because slots 012 are provided on a surface of the waveguide 011, the signal is continuously leaked from the slots 012 during the propagation in the waveguide 011. Provided positions of the slots 012 and relative positions between the slots 012 affect radiation performance of the slotted waveguide antenna 01.

Further, FIG. 5 is a top view of FIG. 4. In FIG. 5, a dashed line represents a center line of the waveguide 011, and the center line may also be understood as a virtual symmetry line along the length direction of the waveguide 011. One of the slots 012 is used as an example. A distance between the slot 012 and the center line of the waveguide is s. An amplitude of a signal leaked from the slot 012 may be adjusted by adjusting s. Usually, a larger value of s indicates a higher amplitude of the leaked signal, and a smaller value of s indicates a lower amplitude of the leaked signal. When s is zero, the slot 012 does not change current distribution on the surface of the waveguide 011. In this case, the signal is not leaked from the slot 012.

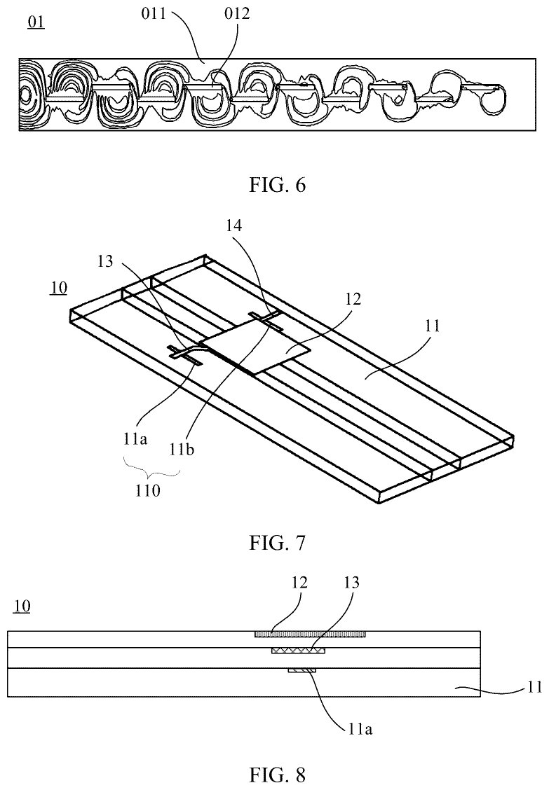

FIG. 6 shows electric field distribution when the signal is propagated in the waveguide 011. The signal is propagated from left to right in the waveguide. As shown in the figure, electric field strength attenuates from left to right. If a slotted waveguide antenna 01 with a higher gain needs to be designed, the distance between the slot 12 and the center line may be appropriately reduced, and a quantity of provided slots 012 is increased, so that an amplitude of a signal leaked from a single slot 012 is reduced, and more slots 012 participate in radiation.

In addition, in the example in FIG. 5, a distance between two adjacent slots 012 is d=λ/2, where λ is a wavelength at which an electromagnetic wave is propagated in the waveguide 011. If the two slots 012 are located on a same side of the center line, and a phase difference of signals leaked from the two slots is 180°, radiated signals are radiated toward one end of the waveguide 011. If the two slots 012 are located on two sides of the center line, and a phase difference of signals leaked from the two slots 012 is zero, radiated signals are radiated toward a normal direction of the waveguide 011. In summary, when a phase difference of electromagnetic waves leaked from the two slots 012 is an odd multiple of 180°, a radiation direction of the electromagnetic wave is consistent with the length direction of the waveguide 011. When a phase difference of electromagnetic waves leaked from the two slots 012 is 0° or 360°, a radiation direction of the electromagnetic wave is consistent with the normal direction of the waveguide 011. Therefore, during actual application, a radiation direction of the electrical antenna 01 may be adjusted by adjusting the phase difference of the electromagnetic waves leaked from the two slots 011.

The antenna provided in this disclosure is described below in detail with reference to the accompanying drawings and embodiments.

As shown in FIG. 7, in an example provided in this disclosure, an antenna 10 may include a waveguide structure 11, a radiating element 12, and a microstrip structure. The waveguide structure 11 includes a slot pair 110 for leaking electromagnetic waves with an approximately same amplitude. Further, the slot pair 110 includes a first slot 11a and a second slot 11b, and a length direction of the first slot 11a is parallel to a length direction of the second slot 11b, so that disturbance caused when a signal is propagated in a waveguide can be reduced, to improve a gain and other performance of the antenna 10. In addition, the microstrip structure includes a first microstrip 13 and a second microstrip 14. The first microstrip 13 is coupled to the first slot 11a, so that a signal in the waveguide structure 11 can be coupled to the first microstrip 13 through the first slot 11a. The first microstrip 13 has a first feeding part, and the first feeding part is connected to the radiating element 12 for feeding, to enable the radiating element 12 to radiate the signal outwards. The second microstrip 14 is coupled to the second slot 11b, so that a signal in the waveguide structure 11 can be coupled to the second microstrip 14 through the second slot 11b. The second microstrip 14 has a second feeding part, and the second feeding part is connected to the radiating element 12 for feeding, to enable the radiating element 12 to radiate the signal outwards. In addition, because the first feeding part is arranged orthogonally to the second feeding part, polarization directions of signals fed into the radiating element 12 may be perpendicular to each other. In addition, a phase difference between an electromagnetic wave of the first feeding part and an electromagnetic wave of the second feeding part is an odd multiple of 90°, so that the radiating element 12 can generate a circularly polarized wave. In summary, amplitudes and polarization directions of signals leaked from the first slot 11a and the second slot 11b are the same. When the signals are propagated in the first microstrip 13 and the second microstrip 14, because the first feeding part is arranged orthogonally to the second feeding part, the polarization directions of the two signals change from an identical state to an orthogonal state. In addition, when the two signals are fed into the radiating element 12, a phase difference is 90°, so that the radiating element 12 can be excited to generate a circularly polarized wave.

In the antenna provided in this embodiment of this disclosure, the first slot 11a and the second slot 11b in the slot pair 110 have a same length direction, that is, the first slot 11a is parallel to the second slot 11b. This can reduce design difficulty, effectively reduce disturbance of the first slot 11a and the second slot 11b to signals propagated in the waveguide structure 11, and help ensure signal transmission quality. In addition, the amplitudes of signals leaked from the first slot 11a and the second slot 11b can be reduced, thereby helping improve a gain of the antenna 10. In addition, the first feeding part is arranged orthogonally to the second feeding part, and a polarization direction of an electromagnetic wave may be adjusted through the microstrip structure, so that the polarization directions of the two signals fed into the radiating element 12 can be perpendicular to each other, thereby enabling the radiating element 12 to generate the circularly polarized wave.

It should be noted that coupling refers to an effective connection of signals or energy between two components, but does not limit a connection manner. During actual application, coupling between the two components may be implemented through a plurality of different connection structures. This is not limited in this disclosure.

For the waveguide structure 11, during actual application, the waveguide structure 11 may be a metal waveguide, may be a substrate-integrated waveguide, or the like. A specific type and shape of the waveguide structure 11 are not limited in this disclosure.

For the first microstrip 13 and the second microstrip 14, during actual application, types of the first microstrip 13 and the second microstrip 14 may be the same, to ensure consistency when signals are propagated in the first microstrip 13 and the second microstrip 14. In addition, the first feeding part and the second feeding part are parts that feed the radiating element 12, and do not refer to specific structures on the first microstrip 13 and the second microstrip 14. During actual application, the first microstrip 13 may be connected to the radiating element 12 in a direct feeding manner. For example, the first microstrip 13 may be electrically connected to the radiating element 12. Alternatively, the first microstrip 13 may be connected to the radiating element 12 in an indirect feeding manner. For example, the first microstrip 13 may not be in direct contact with the radiating element 12, and a signal in the first microstrip 13 may be radiated to the radiating element 12. In addition, a manner of implementing a feeding connection between the second microstrip 14 and the radiating element 12 may be the same as or similar to a manner of implementing a feeding connection between the first microstrip 13 and the radiating element 12. Details are not described herein again.

In addition, a specific manner in which the first feeding part is arranged orthogonally to the second feeding part may also be diverse.

For example, the first microstrip 13 and the second microstrip 14 that are in a straight line shape may be bent, so that the first feeding part is orthogonal to the second feeding part in space. Alternatively, it may be understood that, because the signals propagated in the first microstrip 13 and the second microstrip 14 are both linearly polarized electromagnetic waves, and the polarization directions of the signals are the same when the signals are leaked from the first slot 11a and the second slot 11b, after the first feeding part is arranged orthogonally to the second feeding part, the polarization directions of the two signals fed into the radiating element 12 by the first feeding part and the second feeding part are perpendicular to each other.

In a specific configuration, the first microstrip 13 and the second microstrip 14 may be separately bent by 45°, so that the first feeding part is orthogonal to the second feeding part. Alternatively, the first microstrip 13 may be bent by 90°, and the second microstrip 14 is not bent. Alternatively, the first microstrip 13 may be bent by 30°, and the second microstrip 14 may be bent by 60°. It may be understood that, during actual application, specific shapes of the first microstrip 13 and the second microstrip 14 may be properly configured based on an actual requirement, so that the first feeding part is orthogonal to the second feeding part. This is not limited in this disclosure.

In addition, phases of the signals fed into the radiating element 12 may also be adjusted by adjusting lengths of the first microstrip 13 and the second microstrip 14. For example, when the lengths of the first microstrip 13 and the second microstrip 14 are the same, distances over which the signals are propagated in the first microstrip 13 and the second microstrip 14 are the same. Therefore, no difference is caused between the phases of the two signals. When the lengths of the first microstrip 13 and the second microstrip 14 are different, distances over which the signals are propagated in the first microstrip 13 and the second microstrip 14 are different. Therefore, a difference is caused between the phases of the two signals.

Further, it is assumed that the first microstrip 13 and the second microstrip 14 are of a same structure type, the length of the first microstrip 13 is ¾, and the length of the second microstrip 14 is 2, where λ is a wavelength at which an electromagnetic wave is propagated in the first microstrip 13 or the second microstrip 14. If the phases of the signals propagated into the first microstrip 13 and the second microstrip 14 are both 0°, the phase of the signal propagated out of the first microstrip 13 is 270°, the phase of the signal propagated out of the second microstrip 14 is 360°, and a phase difference between the two signals is 90°. Therefore, the phase difference of the signals fed into the radiating element 12 may alternatively be changed by properly setting the lengths of the first microstrip 13 and the second microstrip 14, so that the phase difference is 90°, to enable the radiating element 12 to generate the circularly polarized wave.

The radiating element 12 is a unit that forms a basic structure of the antenna, and can effectively radiate or receive an electromagnetic wave. During specific application, the radiating element 12 may be a patch antenna, a dipole antenna, or the like. A specific type of the radiating element 12 is not limited in this disclosure.

In addition, as shown in FIG. 8, in a specific configuration, the waveguide structure 11, the microstrip structure, and the radiating element 12 may be stacked on a substrate, to improve integration of the antenna 10. The substrate may be a printed circuit board (PCB), a flexible printed circuit board (FPC), or the like. A specific type and a quantity of layers of the substrate are not limited in this disclosure.

During specific implementation, the waveguide structure 11 may be arranged in various manners.

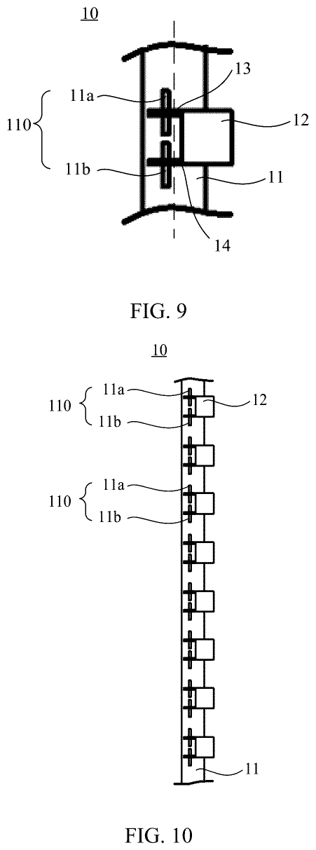

For example, as shown in FIG. 9, in an example provided in this disclosure, the first slot 11a and the second slot 11b in the slot pair 110 are located in a same waveguide 11.

In a specific configuration, positions of the first slot 11a and the second slot 11b may be properly configured based on an actual requirement, so that amplitudes of electromagnetic waves leaked from the first slot 11a and the second slot 11b are the same. For example, a distance between the first slot 11a and a center line (a dashed line in the figure) may be the same as a distance between the second slot 11b and the center line. The same means being approximately the same, and is not absolutely the same in a strict sense. In addition, in a specific configuration, the first slot 11a and the second slot 11b may be located on a same side of the center line, or may be located on two sides of the center line.

In addition, in a length direction of the waveguide 11, a distance between the first slot 11a and the second slot 11b may also be properly set based on a required phase difference of signals.

For example, when a phase difference between the first slot 11a and the second slot 11b is required to be 90°, the distance between the first slot 11a and the second slot 11b may be ¼λ. λ is a wavelength at which a signal is propagated in a waveguide.

In addition, during actual application, a plurality of slot pairs 110 may be provided, to improve a radiation gain of the antenna 10.

For example, as shown in FIG. 10, in an example provided in this disclosure, the plurality of (eight shown in the figure) slot pairs 110 are provided along the length direction of the waveguide 11.

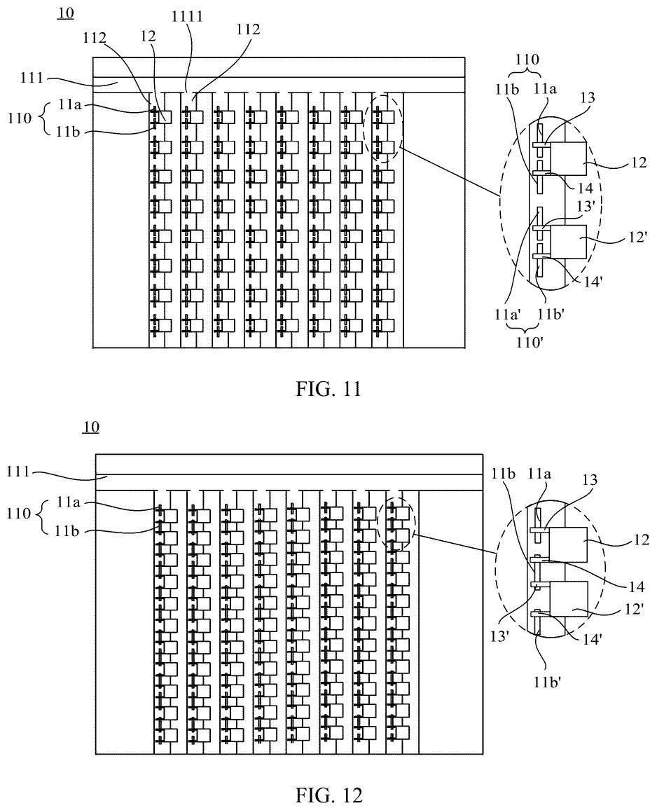

In addition, as shown in FIG. 11, in another example provided in this disclosure, the waveguide structure 11 includes a main waveguide 111 and a plurality of sub-waveguides arranged in parallel. The main waveguide 111 has a plurality of output ends 1111, and input ends of the sub-waveguides are coupled to the output ends 1111 in one-to-one correspondence.

Further, in the example shown in FIG. 11, the output ends 1111 of the main waveguide 111 are arranged in sequence along a length direction (from left to right in FIG. 11) of the main waveguide 111, and the plurality of output ends 1111 are all located on a same side (a lower side in the figure) of the main waveguide 111. A quantity of disposed sub-waveguides is the same as a quantity of disposed output ends 1111 of the main waveguide 111. One end (that is, an input end) of each sub-waveguide is coupled to each of the output ends 1111 of the main waveguide 111 in one-to-one correspondence. A signal in the main waveguide 111 may be propagated to the sub-waveguide through the output end 1111, and then leaked outwards through a slot of the sub-waveguide.

During specific application, the output end 1111 of the main waveguide 111 may be a notch. The notch may be in a shape of a rectangle, a circle, an ellipse, or another polygon. A specific shape of the notch is not limited in this disclosure.

In addition, a position of the output end 1111 may be properly configured based on an actual requirement.

For example, a distance between two adjacent output ends 1111 may be ¼λ. λ is a wavelength at which a signal is propagated in the main waveguide 111. In this case, a phase difference between signals in two adjacent sub-waveguides is 90°. It may be understood that, during specific application, relative distances between the output ends 1111 may be properly set based on an actual requirement. This is not limited in this disclosure.

In addition, as shown in FIG. 12, in another example provided in this disclosure, one slot may be shared in two adjacent slot pairs 110.

For details, refer to FIG. 11 and FIG. 12.

In FIG. 11, the first slot 11a and the second slot 11b form the slot pair 110, the first slot 11a feeds the radiating element 12 through the first microstrip 13, and the second slot 11b feeds the radiating element 12 through the second microstrip 14. A first slot 11a′ and a second slot 11b′ form a slot pair 110′, the first slot 11a′ feeds a radiating element 12′ through a first microstrip 13′, and the second slot 11b′ feeds the radiating element 12′ through a second microstrip 14′.

In FIG. 12, the first slot 11a feeds the radiating element 12 through the first microstrip 13, the second slot 11b feeds the radiating element 12 through the second microstrip 14, the second slot 11b feeds the radiating element 12′ through the first microstrip 13′, and the second slot 11b′ feeds the radiating element 12 through the second microstrip 14′.

It can be learned through comparison between FIG. 11 and FIG. 12 that, in FIG. 12, it may be considered that the first slot 11a′ is omitted, that is, one slot may be shared in the two adjacent slot pairs 110. Certainly, the second slot 11b in FIG. 12 may also be considered as the first slot 11a′ in FIG. 11. Therefore, it may be considered that the second slot 11b is omitted.

A quantity of disposed radiating elements 12 can be effectively increased by sharing a slot, thereby effectively increasing layout density of the radiating element 12, and helping improve a radiation gain of the antenna 10.

Certainly, when the waveguide structure 11 includes at least two sub-waveguides, the two waveguides may form a sub-waveguide pair, that is, the first slot 11a and the second slot 11b in the slot pair 110 may be respectively located in the sub-waveguide pair.

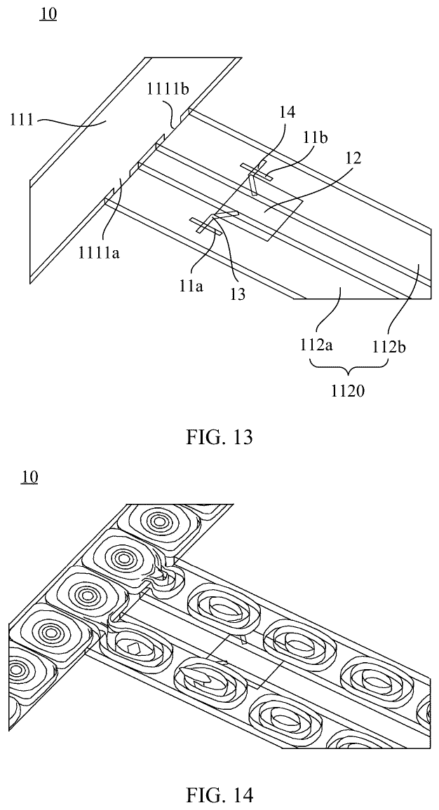

Further, as shown in FIG. 13, a first sub-waveguide 112a and a second sub-waveguide 112b may form a sub-waveguide pair 1120. The first sub-waveguide 112a has the first slot 11a, the second sub-waveguide 112b has the second slot 11b, and the first slot 11a and the second slot 11b form a slot pair.

The first slot 11a is coupled to the first microstrip 13, the second slot 11b is coupled to the second microstrip 14, and both the first microstrip 13 and the second microstrip 14 are connected to the radiating element 12 for feeding.

During specific application, phases of initial electromagnetic waves in the first sub-waveguide 112a or the second sub-waveguide 112b may be different, so that a phase difference of electromagnetic waves leaked from the first slot 11a and the second slot 11b can be adjusted.

For example, as shown in FIG. 13, in an example provided in this disclosure, the first sub-waveguide 112a and the second sub-waveguide 112b are connected to the same main waveguide 111. Two output ends 1111, namely, an output end 1111a and an output end 1111b, are spaced apart from each other in a length direction of the main waveguide 111.

As shown in FIG. 14, in the main waveguide 111, an electromagnetic wave may be propagated from one end (for example, a lower left end in the figure) to the other end (for example, an upper right end in the figure).

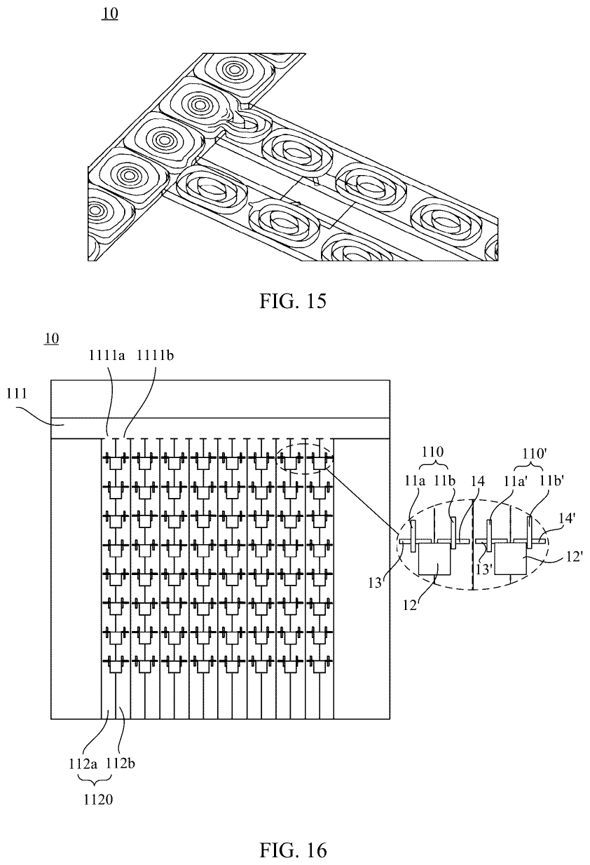

Alternatively, as shown in FIG. 15, in the main waveguide 111, an electromagnetic wave may be propagated from the other end (for example, an upper right end in the figure) to one end (for example, a lower left end in the figure).

A distance between the output end 1111a and the output end 1111b may be an odd multiple of ¼λ, where λ is a wavelength at which an electromagnetic wave is propagated in the main waveguide 111.

A phase difference between electromagnetic waves of the first sub-waveguide 112a and the second sub-waveguide 112b may be 90°, a distance between the first slot 11a and the output end 1111a may be λ, and a distance between the second slot 11b and the output end 1111b may also be λ. In this case, the phase difference of the electromagnetic waves leaked from the first slot 11a and the second slot 11b is 90°.

During actual application, the distance between the output end 1111a and the output end 1111b may be adjusted based on different requirements, or the distance between the first slot 11a and the output end 1111a and the distance between the second slot 11b and the output end 1111b may be properly adjusted. This is not limited in this disclosure.

In addition, as shown in FIG. 16, in another example provided in this disclosure, the waveguide structure 11 may further include a plurality of sub-waveguide pairs 1120, and the main waveguide 111 has a plurality of output ends configured to be coupled to a first sub-waveguide 112a or a second sub-waveguide 112b in the sub-waveguide pair 1120.

It should be noted that, for ease of understanding the technical solutions of this disclosure, the output ends of the main waveguide 111 are described as a first output end 1111a and a second output end 1111b below. The first output end 1111a is coupled to an input end of the first sub-waveguide 112a, and the second output end 1111b is coupled to an input end of the second sub-waveguide 112b.

Further, in the example shown in FIG. 16, the first output end 1111a and the second output end 1111b of the main waveguide 111 are arranged in pairs, and are arranged in pairs in sequence along a length direction of the main waveguide 111. In addition, both the first output end 1111a and the second output end 1111b are located on a same side of the main waveguide 111. A quantity of disposed first sub-waveguides 112a is the same as a quantity of disposed first output ends 1111a of the main waveguide 111.

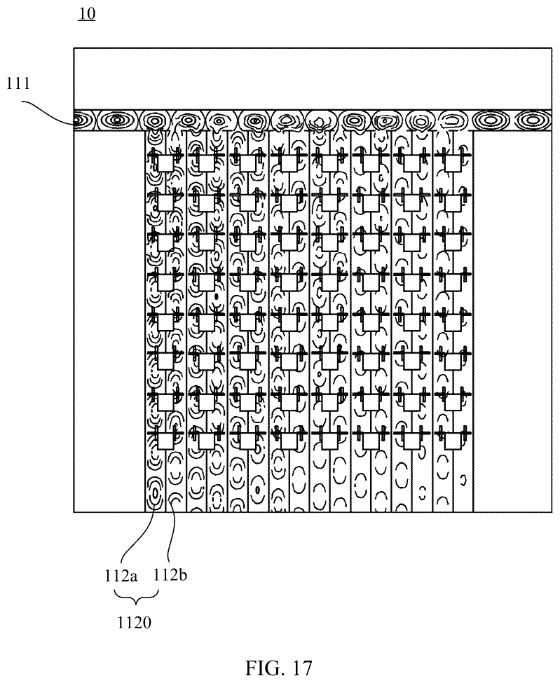

FIG. 17 shows electric field strength distribution of a signal in the waveguide structure 11. In the main waveguide 111, the signal is propagated from left to right. In each sub-waveguide, the signal is propagated from top to bottom. Further, one end (that is, an input end) of each first sub-waveguide 112a is coupled to each of the first output ends 1111 of the main waveguide 111 in one-to-one correspondence. The signal in the main waveguide 111 may be propagated to the first sub-waveguide 112a through the first output end 1111, and then leaked outwards through the first slot 11a of the first sub-waveguide 112a. Correspondingly, a quantity of disposed second sub-waveguides 112b is the same as a quantity of disposed second output ends 1111 of the main waveguide 111. One end (that is, an input end) of each second sub-waveguide 112b is coupled to each of the second output ends 1111 of the main waveguide 111 in one-to-one correspondence. The signal in the main waveguide 111 may be propagated to the second sub-waveguide 112b through the second output end 1111, and then leaked outwards through the second slot 11b of the second sub-waveguide 112b.

During specific application, the first output end 1111 or the second output end 1111 of the main waveguide 111 may be a notch. The notch may be in a shape of a rectangle, a circle, an ellipse, or another polygon. A specific shape of the notch is not limited in this disclosure.

In addition, positions of the first output end 1111 and the second output end 1111 may be properly configured based on an actual requirement.

For example, in a first output end 1111 and a second output end 1111 that are arranged in pairs, a distance between the first output end 1111 and the second output end 1111 may be ¼λ. λ is a wavelength at which an electromagnetic wave is propagated in the main waveguide 111. In this case, a phase difference between electromagnetic waves in the first output end 1111 and the second output end 1111 is 90°. It may be understood that, during specific application, relative distances between the output ends 1111 may be properly set based on an actual requirement. This is not limited in this disclosure.

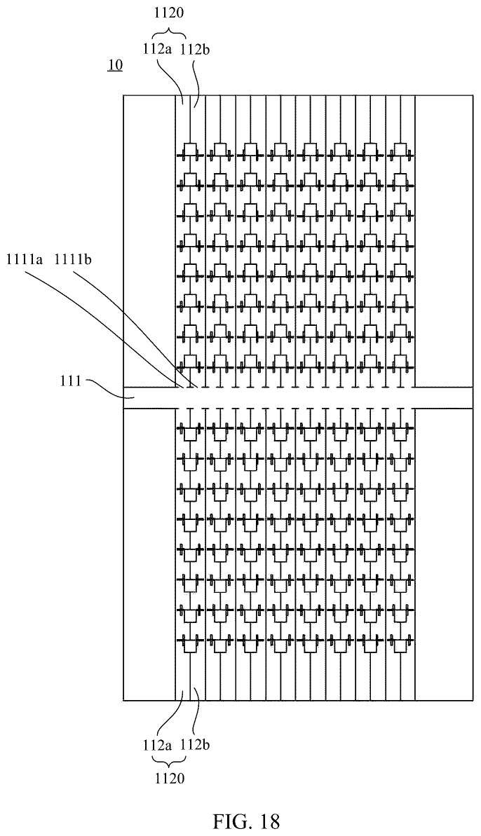

In addition, as shown in FIG. 18, in a specific configuration, the plurality of output ends 1111 may alternatively be located on two opposite sides of the main waveguide 111, and the first output end 1111 and second output end 1111 that are arranged in pairs are located on a same side of the main waveguide 111.

After the first sub-waveguide 112a and the second sub-waveguide 112b are coupled to the main waveguide 111, sub-waveguides may be distributed in pairs on the two opposite sides of the main waveguide 111, so that an average distance from a feeding port (for example, an input end of the main waveguide 111) to each radiating element 12 (or each slot) can be effectively reduced, thereby helping reduce an insertion loss of the antenna 10.

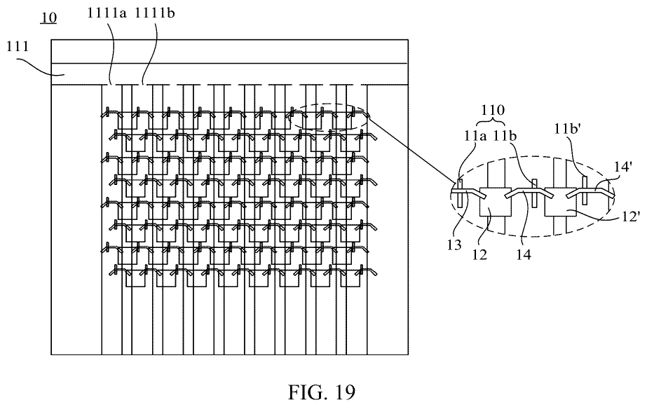

In addition, as shown in FIG. 19, in another example provided in this disclosure, one slot may be shared in two adjacent slot pairs 110.

For details, refer to FIG. 16 and FIG. 19.

In FIG. 16, the first slot 11a and the second slot 11b form the slot pair 110, the first slot 11a feeds the radiating element 12 through the first microstrip 13, and the second slot 11b feeds the radiating element 12 through the second microstrip 14. A first slot 11a′ and a second slot 11b′ form a slot pair 110′, the first slot 11a′ feeds a radiating element 12′ through a first microstrip 13′, and the second slot 11b′ feeds the radiating element 12′ through a second microstrip 14′.

In FIG. 19, the first slot 11a feeds the radiating element 12 through the first microstrip 13, the second slot 11b feeds the radiating element 12 and the radiating element 12′ through the second microstrip 14, and the second slot 11b′ feeds the radiating element 12′ through the second microstrip 14′.

It can be learned through comparison between FIG. 16 and FIG. 19 that, in FIG. 19, it may be considered that the first slot 11a′ and the first microstrip 13′ are omitted. That is, in two adjacent slot pairs, one slot may be shared, and one microstrip may also be shared. Certainly, the second slot 11b in FIG. 19 may also be considered as the first slot 11a′ in FIG. 16, and the second microstrip 14 in FIG. 19 may also be considered as the first microstrip 13′ in FIG. 16.

A quantity of disposed radiating elements 12 can be effectively increased by sharing a slot and a microstrip, thereby effectively increasing layout density of the radiating element 12, and helping improve a radiation gain of the antenna 10.

In addition, during actual application, to improve the gain of the antenna 10, radiation directions of all radiating elements 12 shall be consistent. Usually, electromagnetic waves generated by the radiating elements 12 are propagated along a normal direction. This requires that phases of the radiating elements 12 are equal (that is, a phase difference is 0°), or a phase difference is an integer multiple of 360°.

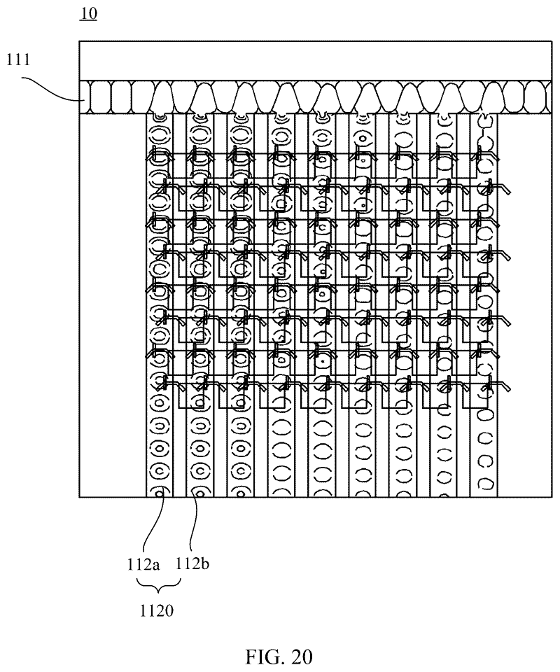

FIG. 20 shows electric field strength distribution of a signal in the waveguide structure 11. In the main waveguide 111, the signal is propagated from left to right. In each sub-waveguide, the signal is propagated from top to bottom. One end (that is, an input end) of each first sub-waveguide 112a is coupled to each of the first output ends 1111 of the main waveguide 111 in one-to-one correspondence. The signal in the main waveguide 111 may be propagated to the first sub-waveguide 112a through the first output end 1111, and then leaked outwards through the first slot 11a of the first sub-waveguide 112a. Correspondingly, a quantity of disposed second sub-waveguides 112b is the same as a quantity of disposed second output ends 1111 of the main waveguide 111. One end (that is, an input end) of each second sub-waveguide 112b is coupled to each of the second output ends 1111 of the main waveguide 111 in one-to-one correspondence. The signal in the main waveguide 111 may be propagated to the second sub-waveguide 112b through the second output end 1111, and then leaked outwards through the second slot 11b of the second sub-waveguide 112b.

In summary, during actual application, a phase difference of electromagnetic waves fed into a corresponding radiating element 12 may be an odd multiple of 90° by adjusting positions of the first slot 11a and the second slot 11b in the slot pair, lengths of the first microstrip 13 and the second microstrip 14, and relative positions of the output ends 1111 of the main waveguide 111, to enable the radiating element 12 to generate circularly polarized radiation.

Alternatively, in some manners, phases of electromagnetic waves fed into the radiating element 12 may be adjusted through a phase shifter 15.

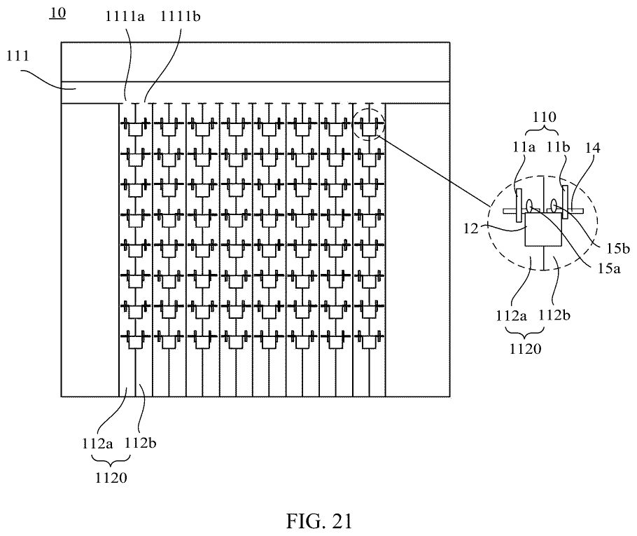

Further, as shown in FIG. 21, in an example provided in this disclosure, a phase shifter 15a and a phase shifter 15b are included. The first microstrip 13 is connected to the radiating element 12 through the phase shifter 15a, and the second microstrip 14 is connected to the radiating element 12 through the phase shifter 15b. The phase shifter 15a and the phase shifter 15b may respectively adjust the phases of the electromagnetic waves fed into the radiating element 12, so that the phase difference of the electromagnetic waves fed into the radiating element 12 is the odd multiple of 90°, thereby enabling the radiating element 12 to generate the circularly polarized radiation.

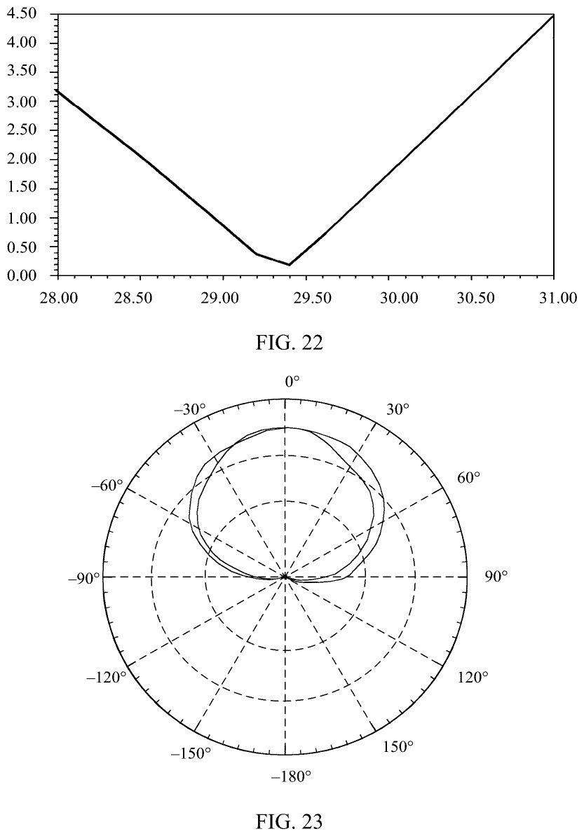

In addition, FIG. 22 and FIG. 23 each show an experimental simulation diagram when the antenna 10 includes a single radiating element. For a specific structure of the antenna 10, refer to FIG. 7 or FIG. 13. Details are not described herein again.

FIG. 22 shows an axial ratio bandwidth of the antenna. In the figure, an abscissa represents a frequency in a unit of gigahertz (GHz), and an ordinate represents power in a unit of decibel (dB). During actual application, an operating bandwidth of the antenna is usually characterized by a frequency with power below 3 dB. It can be learned from the figure that the operating bandwidth of the antenna 10 approximately ranges from 28.05 GHz to 30.45 GHz. In other words, the antenna has a large operating bandwidth, and can meet an actual use requirement.

In addition, FIG. 23 shows a radiation pattern of the antenna. In FIG. 23, a contour S1 represents a pattern of an H-plane (or a magnetic plane). A contour S2 represents a pattern of an E-plane (or an electrical plane). As shown in the figure, the pattern of the antenna has good roundness and a good radiation gain in an angle range of −40° to 40°.

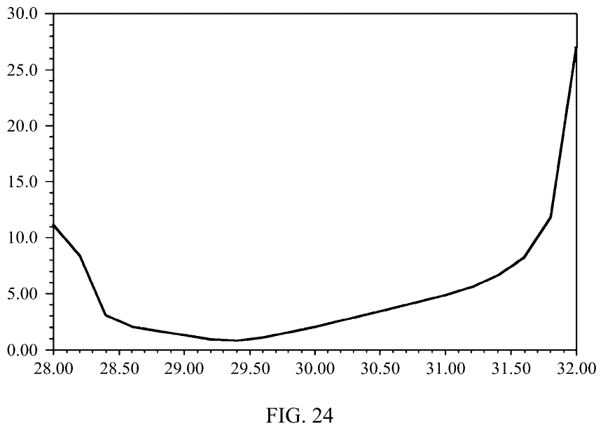

In addition, FIG. 24 shows an experimental simulation diagram when the antenna 10 includes a plurality of radiating elements. For a specific structure of the antenna 10, refer to FIG. 16. Details are not described herein again.

In FIG. 24, an abscissa represents frequency in a unit of GHz, and an ordinate represents power in a unit of dB. During actual application, an operating bandwidth of the antenna is usually characterized by a frequency with power below 3 dB. It can be learned from the figure that the operating bandwidth of the antenna 10 approximately ranges from 28.4 GHz to 30.45 GHz. In other words, the antenna has a large operating bandwidth, and can meet an actual use requirement.

In addition, during actual application, the antenna 10 may be used in a plurality of different types of communication devices.

For example, the antenna 10 may be used in a radar. The radar may include a housing and any one of the foregoing antennas 10. The antenna 10 may be disposed in the housing. In terms of electrical performance, the housing has good electromagnetic wave penetrability, so that normal receiving and sending of an electromagnetic wave between the antenna 10 and the outside are not affected. In terms of mechanical performance, the housing has good force-bearing performance, antioxidation performance, and the like, so that the housing can withstand corrosion of an external harsh environment, and can protect the antenna 10 well. It may be understood that, during specific application, a specific shape and material of the housing may be properly configured based on an actual situation. This is not limited in this disclosure.

The radar may be used in a terminal such as a vehicle, a ship, a satellite, a flight, or an uncrewed aerial vehicle, to implement a function such as wireless signal transmission or navigation. A specific application scenario of the radar (or the antenna) is not limited in this disclosure.

The foregoing descriptions are merely specific implementations of this disclosure, but are not intended to limit the scope of the protection of this disclosure. Any variation or replacement readily figured out by a person skilled in the art within the technical scope disclosed in this disclosure shall fall within the scope of the protection of this disclosure. Therefore, the scope of the protection of this disclosure shall be subject to the scope of the protection of the claims.

1. An antenna comprising:
a waveguide structure comprising a slot pair configured to output a first electromagnetic wave, wherein the slot pair comprises a first slot and a second slot, and
wherein a length direction of the first slot is parallel to a length direction of the second slot;
a radiating element configured to transmit or receive the first electromagnetic wave; and
a microstrip structure comprising:
a first microstrip coupled to the first slot and comprising a first feeding part, wherein the first feeding part is coupled to the radiating element for feeding; and
a second microstrip coupled to the second slot and comprising a second feeding part arranged orthogonally to the first feeding part, wherein the second feeding part is coupled to the radiating element for feeding,
wherein a phase difference between an electromagnetic wave of the first feeding part and an electromagnetic wave of the second feeding part is an odd multiple of 90°.

2. The antenna of claim 1, wherein the waveguide structure further comprises a sub-waveguide, and wherein the sub-waveguide comprises the first slot and the second slot.

3. The antenna of claim 1, wherein the waveguide structure further comprises sub-waveguides arranged in parallel.

4. The antenna of claim 3, wherein the waveguide structure further comprises a main waveguide, wherein the main waveguide comprises output ends, and wherein the sub-waveguides comprise input ends coupled to the output ends in one-to-one correspondence.

5. The antenna of claim 4, wherein the output ends are distributed on two sides of the main waveguide that face away from each other.

6. The antenna of claim 1, wherein the waveguide structure further comprises a sub-waveguide pair, and wherein the sub-waveguide pair comprises:
a first sub-waveguide comprising the first slot; and
a second sub-waveguide comprising the second slot.

7. The antenna of claim 1, wherein the waveguide structure further comprises sub-waveguide pairs.

8. The antenna according to claim 7, wherein the waveguide structure further comprises a main waveguide, wherein the main waveguide comprises a plurality of first output ends and second output ends that are arranged in pairs, wherein ends of a plurality of first sub-waveguides are coupled to the plurality of first output ends in one-to-one correspondence, and wherein input ends of a plurality of second sub-waveguides are coupled to the plurality of second output ends in one-to-one correspondence.

9. The antenna of claim 8, wherein the first output ends and the second output ends are distributed on two sides of the main waveguide that face away from each other.

10. The antenna of claim 1, wherein the waveguide structure further comprises slot pairs, and wherein the first slot or the second slot is shared in two adjacent slot pairs.

11. The antenna of claim 1, wherein the waveguide structure, the radiating element, and the microstrip structure are stacked together.

12. The antenna of claim 1, further comprising a phase shifter, wherein the phase shifter is coupled to the first microstrip or the second microstrip, and is configured to adjust a phase of an electromagnetic wave fed into the radiating element.

13. A radar comprising:
a housing; and
an antenna disposed in the housing and comprising:
a waveguide structure comprising a slot pair to output a first electromagnetic wave, wherein the slot pair comprises a first slot and a second slot, and wherein a length direction of the first slot is parallel to a length direction of the second slot;
a radiating element configured to transmit or receive the first electromagnetic wave; and
a microstrip structure comprising:
a first microstrip coupled to the first slot and comprising a first feeding part, wherein the first feeding part is coupled to the radiating element for feeding; and
a second microstrip coupled to the second slot and comprising a second feeding part arranged orthogonally to the first feeding part, wherein the second feeding part is coupled to the radiating element for feeding, and
wherein a phase difference between an electromagnetic wave of the first feeding part and an electromagnetic wave of the second feeding part is an odd multiple of 90°.

14. A terminal comprising:
a radar comprising:
a housing; and
an antenna coupled to the housing and comprising:
a waveguide structure comprising a slot pair to output a first electromagnetic wave, wherein the slot pair comprises a first slot and a second slot, and wherein a length direction of the first slot is parallel to a length direction of the second slot;
a radiating element configured to transmit or receive the first electromagnetic wave; and
a microstrip structure comprising:
a first microstrip coupled to the first slot and comprising a first feeding part, wherein the first feeding part is coupled to the radiating element for feeding; and
a second microstrip coupled to the second slot and comprising a second feeding part arranged orthogonally to the first feeding part, wherein the second feeding part is coupled to the radiating element for feeding, and
wherein a phase difference between an electromagnetic wave of the first feeding part and an electromagnetic wave of the second feeding part is an odd multiple of 90°.

15. The terminal of claim 14, wherein the waveguide structure further comprises a sub-waveguide, and wherein the sub-waveguide comprises the first slot and the second slot.

16. The terminal of claim 14, wherein the waveguide structure further comprises sub-waveguides arranged in parallel.

17. The terminal of claim 16, wherein the waveguide structure further comprises a main waveguide, wherein the main waveguide comprises output ends, and wherein the sub-waveguides comprise input ends coupled to the output ends in one-to-one correspondence.

18. The terminal of claim 17, wherein the output ends are distributed on two sides of the main waveguide that face away from each other.

19. The terminal of claim 14, wherein the waveguide structure further comprises a sub-waveguide pair, and wherein the sub-waveguide pair comprises:
a first sub-waveguide comprising the first slot; and
a second sub-waveguide comprising the second slot.

20. The terminal of claim 14, wherein the waveguide structure further comprises sub-waveguide pairs arranged in parallel.
